(19) United States
(12) Patent Application Publication
(10) Pub. No.: US 2005/0164694 A1
(43) Pub. Date: Jul. 28, 2005

(54) Error data recovery system and method in a mobile communication terminal

(76) Inventor: Hyung-Hoon Kim, Suwon-si (KR)

Correspondence Address: DILWORTH & BARRESE, LLP, 333 EARLE OVINGTON BLVD., UNIONDALE, NY, 11553, US

(21) Appl. No.: 11/030,495

(22) Filed: Jan. 6, 2005

(30) Foreign Application Priority Data
Jan. 26, 2004 (KR) 2004-4678

(51) Int. Cl. H04M 3/00; H04M 1/00

(52) U.S. Cl. 455/419; 455/418

(57) ABSTRACT

An error data recovery system and a method in a mobile communication terminal are disclosed including a mobile communication terminal for determining if an error which has been occurred during an operation can be corrected, checking an error occurrence block in which an uncorrectable error has occurred, making a download request for data corresponding to the error occurrence block, receiving a data block corresponding to the error occurrence block from a server, storing the received data block in a predetermined storage area, and using the received data block instead of the error occurrence block. The over-the-air server stores data identical to data stored in the mobile communication terminal, and provides the data block having received the download request from among data stored in advance in the mobile communication terminal, when the download request of the data corresponding to the error occurrence block is received from the mobile communication terminal.

### PRIORITY

This application claims priority to an application entitled “Error Data recovery System and Method in Mobile Communication Terminal” filed in the Korean Intellectual Property Office on Jan. 26, 2004 and assigned Serial No. 2004-4678, the contents of which are hereby incorporated by reference.

### BACKGROUND OF THE INVENTION

1. Field of the Invention

The present invention relates to a mobile communication terminal, and more particularly to an error recovery system and method in a mobile communication terminal.

2. Description of the Related Art

Currently, mobile communication technologies have been rapidly developing. Due to that development mobile communication terminals can perform many various functions. In order to perform the various functions, such mobile communication terminals include highly integrated nonvolatile memories, which are electrically erasable and programmable. The nonvolatile memory is a flash memory such as an erasable programmable read-only memory (EPROM) or an electrically erasable programmable read-only memory (EEPROM), that forms a cell with one transistor, it is electrically erasable and may be classified into a NOR type memory and a NAND type memory. Typically, mobile communication terminals employ the NAND type memory, which is low-priced and has a high capacity and fast operation speed in comparison with the NOR type memory.

However, the NAND type flash memory, is highly probable to cause an abnormal operation of a storage cell of the memory of a mobile communication terminal, while it is employing the memory for performing recording, deleting, and reading of programs. When an abnormal operation has occurred affecting one bit of memory, the mobile communication terminal can recover from such failure by itself, by using the means of an error correction code (ECC) algorithm capable of detecting and correcting the error by adding a predetermined redundancy to input data. However, when an abnormal operation has occurred affecting two bits of memory, the mobile communication terminal cannot correct the failure by itself. When a failure cannot be corrected, the mobile communication terminal checks a bad block including a cell in which the error has occurred, and prevents a program designated as residing in the bad block from being used.

In the prior art, when an error which cannot be corrected by the mobile communication terminal itself has occurred, the error of the terminal has been fixed through a process in which a service engineer from the manufacturing company of the mobile communication terminal visits a user of the mobile communication terminal, or the user visits an agency or an after service center with the mobile communication terminal in which the error occurred. However, such methods waste time, are troublesome, and inconvenient. Accordingly, a more convenient method is required, which can reduce error recovery time.

Meanwhile, in order to update an application program, a font, or contents of the mobile communication terminal, an over-the-air-software download (hereinafter, referred to as an OTA-SD) method has recently been used. Herein, in the OTA-SD method, the terminal itself does not determine whether to perform an update, but instead, a service company to which the terminal belongs transmits a message (e.g., a short message) and allows the terminal to update predetermined data when the terminal has an item to be updated. In a situation in which an error has occurred in the mobile communication terminal, error recovery time may be reduced. Furthermore, it is more convenient for the user of the mobile communication terminal if the error is corrected by means of such an OTA-SD method, instead of requiring that a service engineer from a manufacturing company of the mobile communication terminal visit the user, or the user visit an agency or a service center.

### SUMMARY OF THE INVENTION

Accordingly, the present invention has been made to solve the above-mentioned problems occurring in the prior art, and a first object of the present invention is to provide an error recovery system and method in a mobile communication terminal, which employ an over-the-air-software download (OTA-SD) method in correcting an error, which cannot be corrected by only the mobile communication terminal itself, so that the system and method can reduce error recovery time and provide convenience to a user.

In order to accomplish the aforementioned object, according to one aspect of the present, there is provided a system for correcting erroneous data including a mobile communication terminal for determining whether the mobile communication terminal can correct an error which has occurred during an operation of the mobile communication terminal, checking an error occurrence block in which an uncorrectable error has occurred, making a download request for data corresponding to the error occurrence block to an over the air server, receiving a data block corresponding to the error occurrence block from the over the air server, storing the received data block in a predetermined storage area, and using the received data block instead of the error occurrence block; and the over-the-air server for storing data equal to data stored in the mobile communication terminal, and providing the data block having received the download request from among data stored in advance in the mobile communication terminal, when the download request of the data corresponding to the error occurrence block is received from the mobile communication terminal.

In order to accomplish the aforementioned object, according to another aspect of the present, there is provided a method for correcting erroneous data in a mobile communication terminal, the method including the steps of: the mobile communication terminal determining whether the mobile communication terminal can correct an error which has occurred during operation of the mobile communication terminal; the mobile communication terminal checking an error occurrence block in which an uncorrectable error has occurred, and making a request for download of data corresponding to the error occurrence block to an over-the-air server; the over-the-air server reading the data corresponding to the error occurrence block from a terminal information storage unit storing data equal to data stored in the mobile communication terminal, and providing the read data to the mobile communication terminal, when a request for the download of the data corresponding to the error occurrence block is received from the mobile communication terminal; the mobile communication terminal receiving the data provided from the over-the-air server and storing the received data in a predetermined storage area; and the mobile communication terminal using the downloaded data instead of the data corresponding to the error occurrence block.

### BRIEF DESCRIPTION OF THE DRAWINGS

The above object, features and advantages of the present invention will be more apparent from the following detailed description taken in conjunction with the accompanying drawings, in which:

FIG. 1 is a block diagram of an error recovery system in a mobile communication terminal according to an embodiment of the present invention;

FIG. 2 is a block diagram of a mobile communication terminal according to an embodiment of the present invention;

FIG. 3 is a block diagram showing a data block stored in a memory of a mobile communication terminal according to an embodiment of the present invention;

FIG. 4 is a block diagram showing an example of an error in a data block stored in a memory of a mobile communication terminal according to an embodiment of the present invention;

FIG. 5 is a flowchart, which shows data flow between a mobile communication terminal and an over-the-air server for correcting an error in a mobile communication terminal according to an embodiment of the present invention; and

FIG. 6 is a flowchart, which shows an error recovery process in a mobile communication terminal according to an embodiment of the present invention.

### DETAILED DESCRIPTION OF THE PREFERRED EMBODIMENT

Hereinafter, a preferred embodiment according to the present invention will be described with reference to the accompanying drawings. The same reference numerals are used to designate the same elements as those shown in other drawings. In the description below, many particular items are provided for helping the general understanding of the present invention, it will be understood by those skilled in the art that the present invention can be embodied without the particular items. In the following description of the present invention, a detailed description of known functions and configuration incorporated herein will be omitted when it may make the subject matter of the present invention unclear.

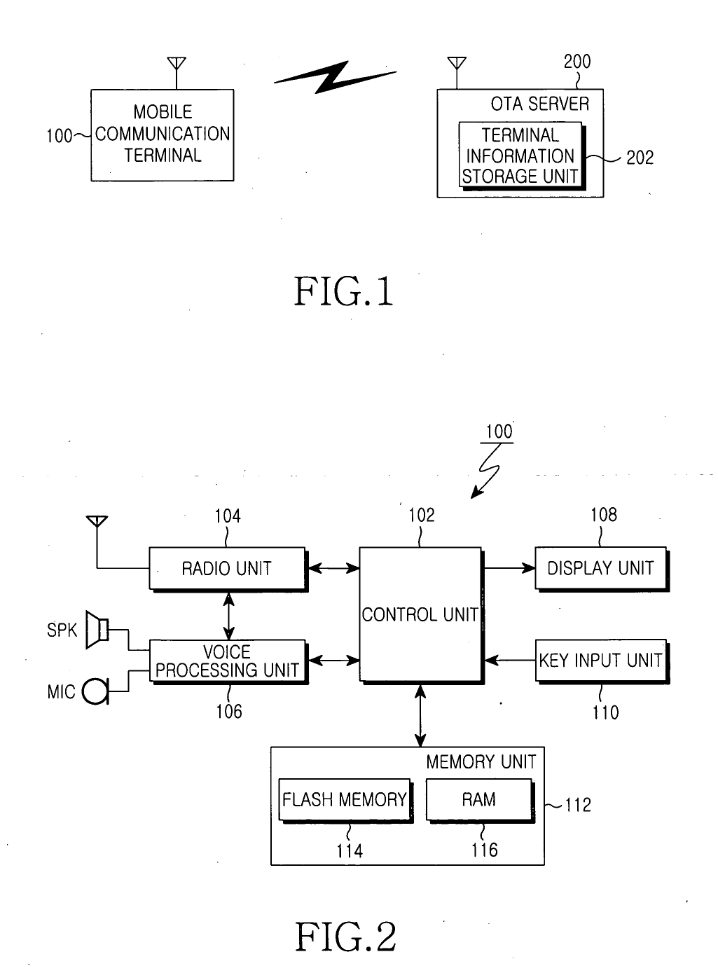

FIG. 1 is a block diagram of an error recovery system in a mobile communication terminal according to an embodiment of the present invention. Referring to FIG. 1, the error recovery system in the mobile communication terminal includes a mobile communication terminal 100 and an over-the-air (OTA) server 200.

When an error occurs during a general terminal operation of the mobile communication terminal 100, the mobile communication terminal 100 examines a memory to check a block (hereinafter, referred to as an error occurrence block) in which the error has occurred, and makes a request for download of data corresponding to the error occurrence block to the over-the-air server 200. When such a download is requested, the mobile communication terminal 100 transmits information (hereinafter, referred to error occurrence block information) for the error occurrence block to the over-the-air server 200.

The over-the-air server 200 includes a terminal information storage unit 202 storing the same data that is stored in the memory of the mobile communication terminal 100. Herein, when both the error occurrence block information and the download request of the data corresponding to the error occurrence block are received from the mobile communication terminal 100, the over-the-air server 200 reads the data corresponding to the error occurrence block from data stored in the terminal information storage unit 202, and downloads the read data to the mobile communication terminal 100.

The mobile communication terminal 100 receives the downloaded data corresponding to the error occurrence block from the over-the-air server 200, stores the received data in a predetermined storage area of the memory, and designates the error occurrence block as a bad block. Then, the mobile communication terminal 100 uses the downloaded data block instead of the error occurrence block. Accordingly, the mobile communication terminal 100 can correct the error occurring during the general terminal operation of the mobile communication terminal 100.

FIG. 2 is a block diagram of the mobile communication terminal 100 according to an embodiment of the present invention. Hereinafter, a construction and an operation of the mobile communication terminal 100 will be described in detail with reference to FIGS. 1 and 2. The mobile communication terminal 100 includes a control unit 102, a radio unit 104, a voice processing unit 106, a display unit 108, a key input unit 110, and a memory unit 112.

The control unit 102 performs a general control operation of the mobile communication terminal 100, checks the error occurrence block when an uncorrectable error occurs during the terminal operation of the mobile communication terminal 100, and performs a control required for receiving the data corresponding to the error occurrence block. Further, when the download of the data corresponding to the error occurrence block has been completed, the control unit 102 uses the downloaded data block instead of the error occurrence block.

When the error occurs during the terminal operation of the mobile communication terminal 100, the radio unit 104 transmits a download request signal for the data corresponding to the error occurrence block to an over the air server 200 (FIG. 1)under the control of the control unit 102, receives the data corresponding to the error occurrence block from the over the air server, and send the received data to the control unit 102.

The voice processing unit 106 controls transferring of voice data and control data as directed by the control unit 102. Further, the voice processing unit 106 converts the voice data received in the radio unit 104 into an audible sound, outputs the converted audible sound through a speaker under the control of the control unit 102, and converts a voice signal inputted through a microphone into digital data to send the converted data to the control unit 102. The display unit 108 may include a liquid crystal display (LCD). It may also output various display data generated by the mobile communication terminal 100, as directed by the control unit 102. The key input unit 110 is a device for an interface with a user. Includes a plurality of keys, and outputs a signal corresponding to a key pressed by the user.

The memory unit 112 stores a plurality of programs and data, and includes a flash memory 114 and a read access memory (RAM) 116. The flash memory 114 may include a memory such as an erasable programmable read-only memory (EPROM) or an electrically erasable programmable read-only memory (EEPROM), forms a cell with one transistor, is electrically erasable, and is an NAND type.

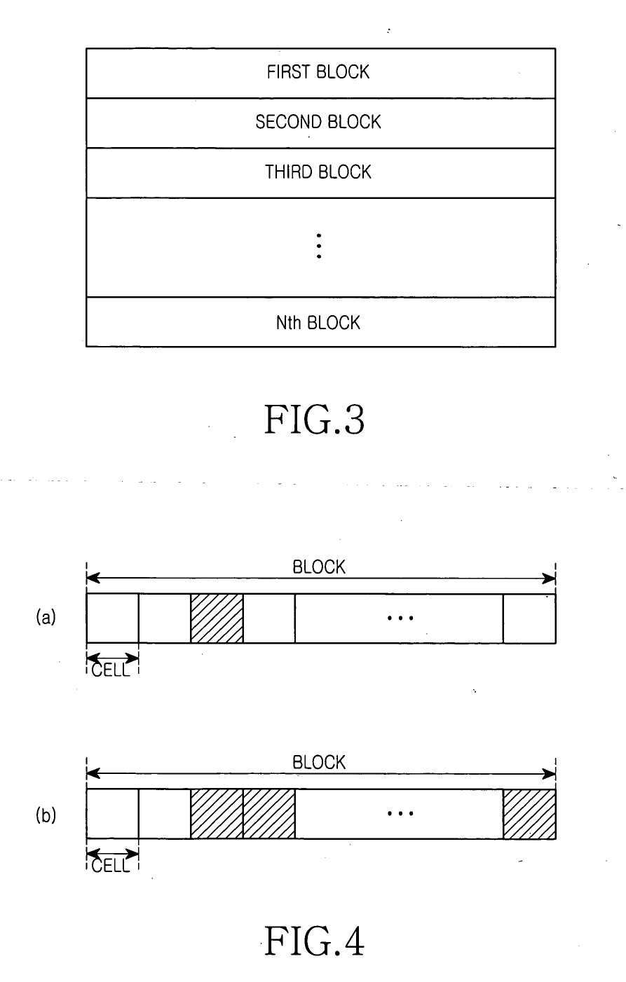

FIG. 3 shows one example of a data storage of the flash memory 114 according to an embodiment of the present invention. Referring to FIG. 3, the flash memory 114 stores programs and data required for the terminal operation in a plurality of blocks (a first to an n^{th} block). Herein, one block includes various cells and each cell stores one bit of data.

Returning to FIG. 2, the mobile communication terminal 100 reads the blocks stored in the flash memory 114 and stores the read blocks in the RAM 116. Then, the mobile communication terminal 100 executes code binaries corresponding to the blocks stored in the RAM 116 in order to perform the general terminal operation. However, when the mobile communication terminal 100 reads the blocks in the flash memory 114, it is highly probable for each cell in the blocks to cause an abnormal physical operation of the mobile communication terminal 100.

FIGS. 4a and 4b show examples of errors in data blocks stored in the flash memory 114. FIG. 4a shows an example of one bit of error having occurred due to an abnormal operation in one cell of one block from among blocks stored in the flash memory 114. FIG. 4b shows an example of two bits or more of error having occurred due to abnormal operations in cells of one block from among blocks stored in the flash memory 114. Herein, when one bit error has occurred as shown in FIG. 4a, the mobile communication terminal 100 can correct the error by itself through an error recovery algorithm such as an error correction code (ECC). However, when two bits or more of error has occurred as shown in FIG. 4b, the ECC algorithm cannot correct the error.

Accordingly, in an embodiment of the present invention, when an error which cannot be corrected by the mobile communication terminal 100 by itself has occurred in the flash memory 114 similarly to a situation in which two bits or more of error have occurred, the mobile communication terminal 100 receives the data corresponding to the error occurrence block from the over-the-air server 200, and uses the received data.

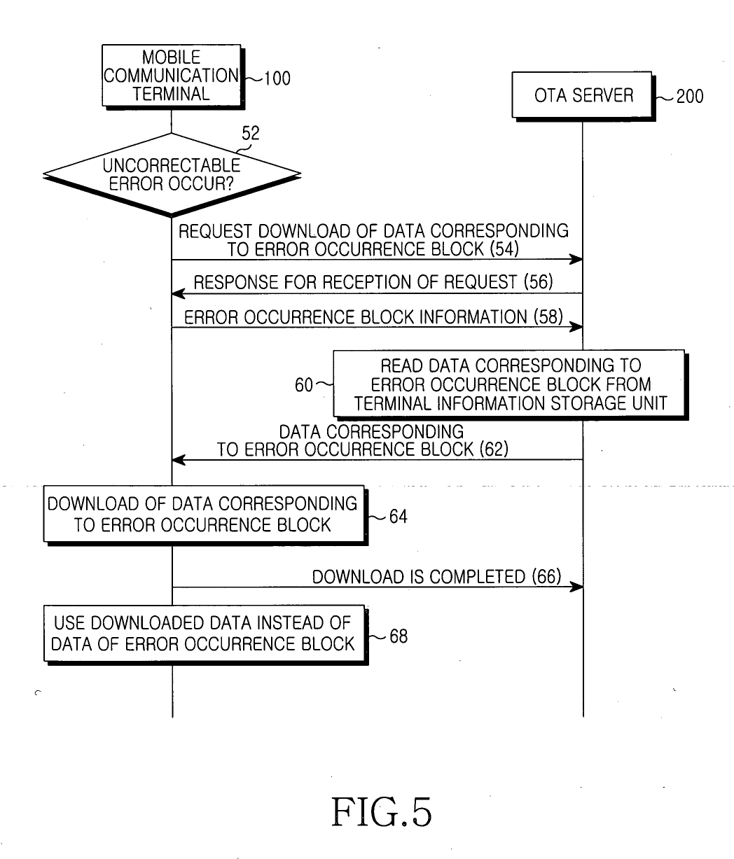

FIG. 5 is a flowchart, which shows data flow between the mobile communication terminal 100 and the over-the-air server 200 for correcting erroneous data.

Hereinafter, a process in which data are transferred between the mobile communication terminal 100 and the over-the-air server 200 in order to correct the erroneous data will be described in detail with reference to FIG. 5.

In step 52 the mobile communication terminal 100 determines whether an uncorrectable error occurs. When an uncorrectable error, such as two bits or more of error occurrence, occurs during the general terminal operation of the mobile communication terminal 100, step 54 is performed. In step 54, the mobile communication terminal 100 makes a request for the download of data corresponding to the error occurrence block to the over-the-air server 200. In step 56, when a download request signal of the data corresponding to the error occurrence block is received from the mobile communication terminal 100, the over-the-air server 200 transmits a response or an acknowledgement signal, which reports that the request signal has been received, to the mobile communication terminal 100.

In step 58, when the response or the acknowledgement signal is received, the mobile communication terminal 100 transmits the error occurrence block information to the over-the-air server 200. In step 60, when the error occurrence block information is received, the over-the-air server 200 reads data corresponding to the received error occurrence block information from the terminal information storage unit 202. Further, in step 62 the over-the-air server 200 transmits the read data corresponding to the received error occurrence block information to the mobile communication terminal 100.

In step 64, the mobile communication terminal 100 receives the data corresponding to the error occurrence block information provided from the over-the-air server 200. In step 66, when the data download has been completed, the mobile communication terminal 100 transmits a data download completion signal to the over-the-air server 200. Then, step 68 is performed. That is, the mobile communication terminal 100 uses the downloaded data instead of the data of the error occurrence block in step 68.

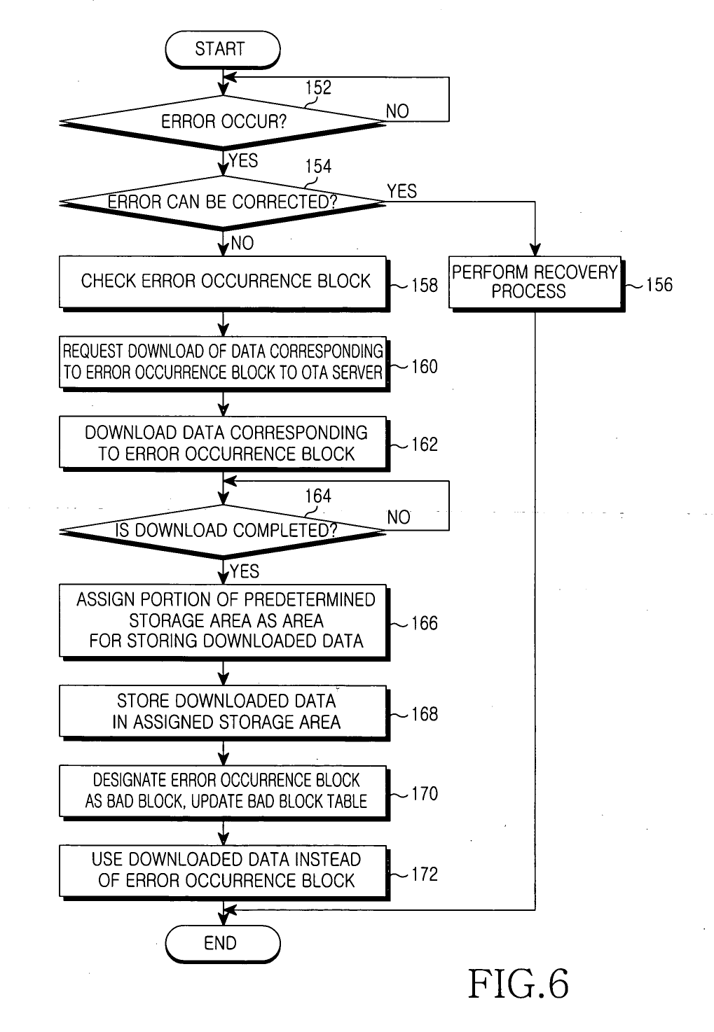

FIG. 6 is a flowchart, which shows an error recovery process in the mobile communication terminal 100. Hereinafter, the error recovery process in the mobile communication terminal 100 will be described in detail with reference to FIG. 6. The mobile communication terminal 100 determines whether an error occurs in step 152. For example, when an error occurs while reading data stored in the flash memory 114, step 154 is performed. That is, the mobile communication terminal 100 determines whether it can correct the error. For example, the mobile communication terminal 100 can correct one bit of error by itself, but cannot correct two bits or more of error. Herein, when the error that has occurred is correctable, the mobile communication terminal 100 performs an error recovery process in step 156. In contrast, when the error that has occurred is an uncorrectable error such as two bits or more of error, step 158 is performed. That is, the mobile communication terminal 100 checks a block of the flash memory 114 in which the error has occurred. Further, in step 160 the mobile communication terminal 100 makes a request for download of data corresponding to the error occurrence block to the over-the-air server 200 through the radio unit 104. Herein, when the mobile communication terminal 100 makes a request for the download of the data corresponding to the error occurrence block to the over-the-air server 200 and a response signal reporting that the request signal has been received, are received from the over-the-air server 200, the mobile communication terminal 100 transmits the error occurrence block information to the over-the-air server 200.

Then, in step 162 the mobile communication terminal 100 receives the data corresponding to the error occurrence block information provided from the over-the-air server 200. Further, in step 164 the mobile communication terminal 100 determines whether the data download has been completed. As a result of the determination, when the data download has been completed, the mobile communication terminal 100 assigns a portion of a predetermined storage area in the flash memory 114 as an area for storing the downloaded data, in step 166. For example, the mobile communication terminal 100 assigns one block of predetermined blocks in the flash memory 114 as the area for storing the downloaded data. Then, in step 168 the mobile communication terminal 100 stores the downloaded data in the assigned storage area. That is, the mobile communication terminal 100 stores the downloaded data in the assigned block. After storing the downloaded data as described above, the mobile communication terminal 100 designates the error occurrence block in the flash memory 114 as a bad block in step 170, and updates a bad block table. Further, in step 172 the mobile communication terminal 100 uses the downloaded data block instead of the error occurrence block.

In the present invention as described above, a mobile communication terminal checks an error occurrence block in a memory when an error occurs during a general terminal operation of the mobile communication terminal, and makes a request for download of data corresponding to the error occurrence block to an over-the-air server. Then, the over-the-air server provides the data corresponding to the error occurrence block to the mobile communication terminal. The mobile communication terminal receives the data corresponding to the error occurrence block from the over-the-air server, stores the downloaded data in a predetermined storage area, designates the error occurrence block as a bad block, and then uses the downloaded data block instead of the error occurrence block. Accordingly, the mobile communication terminal can correct the error occurring during the general terminal operation of the mobile communication terminal. As described above, when the error has occurred in the mobile communication terminal, the error can be corrected by means of such an OTA-SD method, instead of requiring that a service engineer from the manufacturing company of the mobile communication terminal visit a user of the mobile communication terminal, or the user visit an agency or a service center. Therefore, error recovery time can be reduced and the users' convenience enhanced.

While the invention has been shown and described with reference to certain preferred embodiments thereof, it will be understood by those skilled in the art that various changes in form and details may be made therein without departing from the spirit and scope of the invention as defined by the appended claims.

1. A system for correcting erroneous data in a memory of a mobile communication terminal comprising:
a control unit for
determining whether an error which has occurred during operation of the mobile communication terminal can be self corrected by the mobile communication terminal,
checking an error occurrence block in which an uncorrectable error has occurred,
making a download request for data block corresponding to the error occurrence block to a air server,
receiving a data block corresponding to the error occurrence block from the server,
storing the received data block in a predetermined storage area, and
using the received data block instead of the error occurrence block; and
an over-the-air server for
storing data identical to data stored in the mobile communication terminal, and
providing the data block after receiving the download request from among data stored in advance to the mobile communication terminal, when the download request of the data corresponding to the error occurrence block is received from the mobile communication terminal.

2. The system as claimed in claim 1, wherein the mobile communication terminal comprises:
a flash memory for storing a plurality of programs and data for operation of the mobile communication terminal in a plurality of blocks, and including a storage area for storing the data corresponding to the error occurrence block downloaded from the server;
a radio unit for transmitting a download request signal of the data corresponding to the error occurrence block to the server, and receiving the data block corresponding to the error occurrence block from the server; and
the control unit for determining whether the error which has been occurred during operation of the mobile communication terminal can be self corrected by the mobile communication terminal,
checking the error occurrence block, in which the uncorrectable error has occurred, from among the blocks stored in the flash memory,
making a request for the download of the data block corresponding to the error occurrence block to the server through the radio unit,
storing the data block corresponding to the error occurrence block downloaded through the radio unit in the predetermined storage area of the flash memory, and
using the downloaded data block instead of the error occurrence block.

3. The system as claimed in claim 2, wherein the flash memory is an NAND type flash memory.

4. The system as claimed in claim 2, wherein the uncorrectable error is two bits or more of error.

5. A method for correcting erroneous data in a mobile communication terminal, the method comprising the steps of:
determining whether the mobile communication terminal can correct an error that has occurred during operation;
checking an error occurrence block in which an uncorrectable error has occurred, and making a request for download of data corresponding to the error occurrence block to an over-the-air server;
the over-the-air server reading the data corresponding to the error occurrence block, and
providing the read data to the mobile communication terminal, when a request for the download of the data corresponding to the error occurrence block is received from the mobile communication terminal;
the mobile communication terminal receiving the data provided from the over-the-air server and storing the received data in a predetermined storage area; and
the mobile communication terminal using the downloaded data instead of the data corresponding to the error occurrence block.

6. The method as claimed in claim 5, further comprising designating the error occurrence block as a bad block, and updating a bad block table.

7. The method as claimed in claim 5, further comprising a terminal information storage unit storing data equal to data stored in the mobile communication terminal.
